(19) United States
(12) Patent Application Publication
(10) Pub. No.: US 2018/0331977 A1
(43) Pub. Date: Nov. 15, 2018

(54) ETHERNET AGGREGATION BETWEEN AN EDGE DEVICE AND A SWITCH

(71) Applicant: Hewlett Packard Enterprise Development LP, Houston, TX (US)

(72) Inventor: Sandhiya KRISHNASAMY, Bangalore (IN)

(21) Appl. No.: 15/777,539

(22) PCT Filed: Mar. 29, 2016
(86) PCT No.: PCT/US2016/024697

§ 371 Date: May 18, 2018

(30) Foreign Application Priority Data
Nov. 12, 2015 (IN) IN6104/CHE/2015

(51) Int. Cl. H04L 12/931; H04L 29/08

(52) U.S. Cl. CPC H04L 49/357; H04L 67/1097; H04L 49/351

(57) ABSTRACT

In one example, a Fibre Channel over Ethernet (FCoE) network is described, which includes an edge device and a logical link to connect the edge device to an FCoE switch. The edge device includes an edge device FCoE link aggregation sub-layer. The logical link includes multiple FCoE links connected to multiple ports of the edge device. The edge device FCoE link aggregation sub-layer to enable transmission and reception of FCoE frames from/to the edge device via the logical link.

### BACKGROUND

Fibre Channel (FC) is a common storage protocol used in storage area networks (SANs). Fibre Channel over Ethernet (FCoE) can handle both Ethernet and FC traffic in a storage area network (SAN). In such a network, neighboring edge devices and FCoE switches are interconnected via multiple physical links.

### BRIEF DESCRIPTION OF THE DRAWINGS

Examples are described in the following detailed description and in reference to the drawings, in which:

FIG. 1 is an example block diagram of a Fibre Channel over Ethernet (FCoE) network illustrating communication of FCoE frames between an edge device and an FCoE switch via a logical link, according to one aspect of the present subject matter;

FIG. 2 is an example block diagram of an FCoE link aggregation sub-layer illustrating an FCoE aggregation integrated with an Ethernet aggregation, according to one aspect of the present subject matter;

FIG. 2A is a block diagram showing an example implementation of transmission of FCoE frames between the edge device and the FCoE switch via the logical link, according to one aspect of the present subject matter;

FIG. 3 is a timing diagram illustrating an example fabric login (FLOG I) scenario, according to one aspect of the present subject matter;

FIG. 4 is a timing diagram illustrating an example read exchange scenario, according to one aspect of the present subject matter;

FIG. 5 is a timing diagram illustrating an example WRITE exchange scenario, according to one aspect of the present subject matter;

FIG. 6 is a block diagram illustrating an example handling of link down scenario in the integrated FCoE and Ethernet aggregation layers, such as those shown in FIGS. 1 and 2, according to one aspect of the present subject matter;

FIG. 7 is a block diagram illustrating an example handling of link add scenario in the integrated FCoE and Ethernet aggregation layers, such as those shown in FIGS. 1 and 2, according to one aspect of the present subject matter;

FIG. 8 is a block diagram illustrating an example implementation of the FCoE aggregator in a Converged Network Adapter (CNA) firmware, according to one aspect of the present subject matter;

FIG. 9 is a block diagram illustrating an example implementation of FCoE aggregator in a host/operating system, according to one aspect of the present subject matter;

FIGS. 10A and 10B depict example flow charts for FCoE aggregation between an edge device and an FCoE switch in an FCoE network, according to one aspect of the present subject matter; and

FIGS. 11A and 11B depict example block diagrams showing a non-transitory computer-readable media for FCoE aggregation between an edge device and an FCoE switch in an FCoE network.

### DETAILED DESCRIPTION

A data center is a specialized facility that provides data serving and backup as well as other network based services for subscribers and other entities. A data center may consist of a facility that hosts all of the infrastructure equipment, such as edge devices and switches. Example edge devices are networking and storage systems, servers, adapters, redundant power supplies, environmental controls and the like. Fibre Channel (FC) is a standard used to interconnect storage systems and servers in a Storage Area Network (SAN). Fibre Channel over Ethernet (FCoE) is a standard for encapsulating FC traffic within Ethernet frames to, in effect, operate aspects of the SAN over an Ethernet network, which may allow data center administrators to significantly reduce cabling among servers and storage systems and also permits server virtualization within the SAN.

Network switches may use Link Aggregation (LAG) to create a higher bandwidth port channel using multiple switch ports. The LAG is a sub-layer that resides between higher protocol layers and a MAC layer. For example, in Ethernet networking a standard IEEE 802.3ad has been developed for LAG between switches as well as nodes/edge devices. This standard has been implemented in many Ethernet switches. FCoE basically runs on Lossless Ethernet, and may be beneficial for FCoE to re-use the IEEE 802.3ad standard such that LAG may be available for the edge devices of the FCoE network.

The present specification describes a technique for an FCoE edge device to participate in LAG with an FCoE switch, where the FCoE switch is an FCoE forwarder, i.e., the present specification extends the LAG to FCoE network. Further, the present specification describes a technique that may allow for the edge device to have LAG interoperability with an FCoE switch from any vendor by extending the IEEE 802.3ad mechanisms to FCoE. Furthermore, the present specification proposes an FCoE LAG technique between a node/edge device and an FCoE switch in an FCoE network.

In addition, the present specification describes extending the functions of Media Access Control (MAC) aggregator in IEEE 802.1AX for FCoE based operations like fabric logins and FCoE frame encapsulation by modifying frame collector and frame distributor to achieve FCoE LAG between edge devices and switches. Also, the control parser/multiplexer may be modified to handle both Ethernet and FCoE frames and divert the traffic based on the “EtherType”. FC operations, such as fabric login (FLOGI), read exchange, write exchange, link add, link down may be implemented to handle the LAG functions. In addition, the technique may be interoperable such that it can be implemented either in Converged Network Adapter (CNA) firmware or in host operating system (OS). Switch side implementation of LAG function may be implemented in the FCoE switch firmware. In addition, the technique described in the specification may be extended to work between a target N-Port and an FCoE switch.

Further, the present specification describes enabling LAG of FCoE links at the host computing system side of the SAN fabric. In addition, the present specification describes aggregating physical links if a target has native FCoE port support and connects directly to an FCoE switch. LAG may be accomplished by using FCoE LAG function layered between the FCoE driver and the MAC layer at the host. In such a scenario, a corresponding FCoE aggregator may also be needed at the other end, i.e., at the switch ports participating in the LAG.

Furthermore, the present specification describes aggregation of FCoE links using existing Ethernet IEEE 802.3 ad, such that Ethernet frames may be aggregated by the Ethernet aggregator and the FCoE frames may be aggregated separately by the FCoE aggregator. The FCoE SAN administrator may first configure the LAG across both sides of the link at the Ethernet level via the FCoE switch port aggregation commands, setting the virtual local area network (VLAN) identification for FCoE traffic, the OS bonding drivers, and enforcement of the link aggregation control protocol (LACP) on the aggregated Ethernet links. The FCoE aggregator may then detect that Ethernet level aggregation has been configured and accordingly may turn on the FCoE aggregation across the same set of links. In addition, the present specification describes FCoE directly communicating with the MAC layer independent of the Ethernet aggregator. The FCoE frames can be processed by the FCoE aggregator on either side of the link. The other type of protocol frames, such as transmission control protocol/Internet protocol (TCP/IP), international standardized commercial identifier (ISCI) and the like may be processed by the Ethernet aggregator.

Moreover, the present specification describes accomplishing FCoE LAG on both the initiator side of the FCoE fabric as well as the target side of the FCoE fabric. Ethernet IEEE 802.3ad is a widely implemented standard for LAG by OS vendors and switch vendors for both edge access links and inter-switch Ethernet links, which facilitates in extending the current IEEE 802.3ad aggregation code to implement the proposed technique for FCoE LAG. LACP based techniques for LAG also facilitates in controlling both the Ethernet aggregation as well as the FCoE aggregation.

In the following description, for purposes of explanation, numerous specific details are set forth in order to provide a thorough understanding of the present techniques. However the present apparatus, devices and systems may be practiced without these specific details. Reference in the specification to “an example” or similar language means that a particular feature, structure, or characteristic described is included in at least that one example, but not necessarily in other examples.

The terms “node”, “host” and “edge device” are used interchangeably throughout the document. Also, the terms “switch” and “FCoE switch” are used interchangeably throughout the document. Further, the terms “logical channel”, “aggregation”, and “LAG” are used interchangeably throughout the document and refer to combining/aggregating multiple network connections/links in parallel to increase throughput and provide redundancy. Furthermore, the term “host” refers to a host computing system.

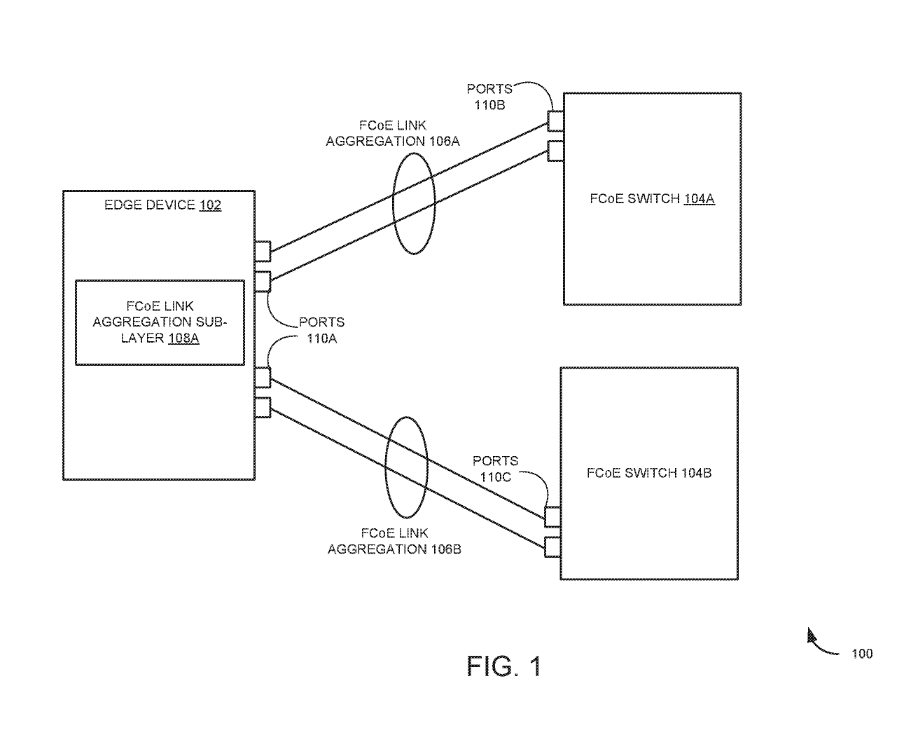

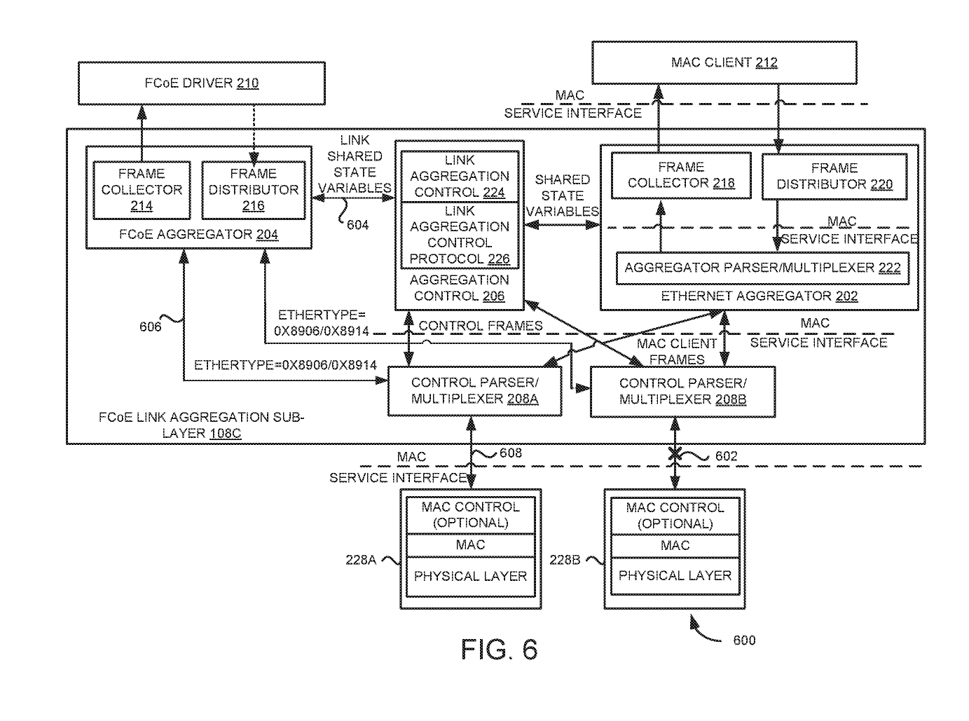

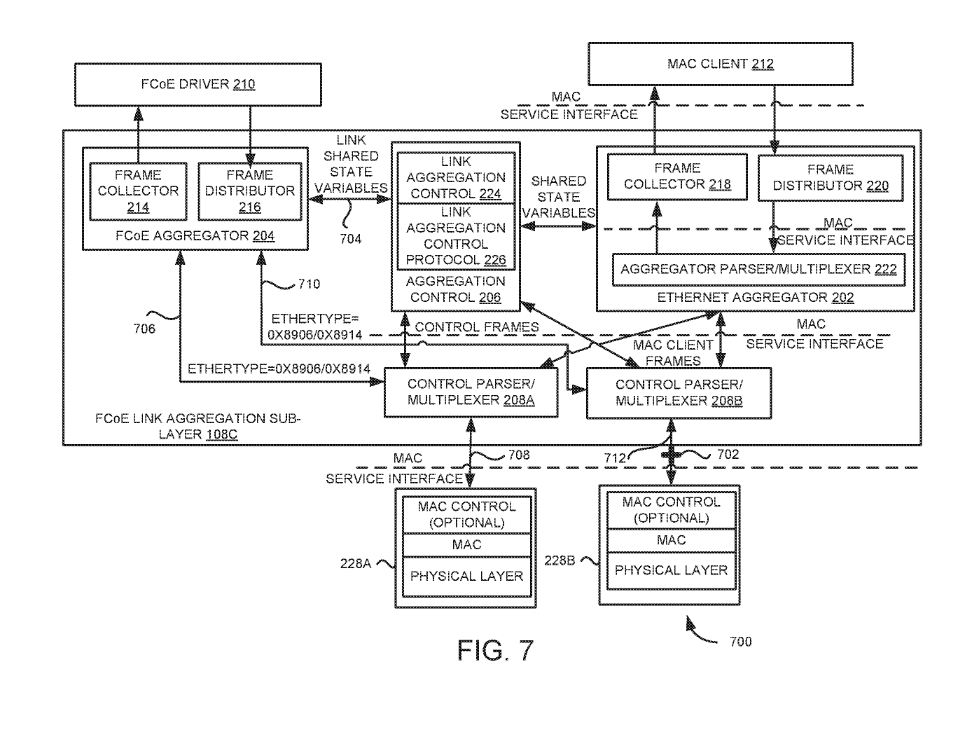

Turning now to the figures, FIG. 1 illustrates an example block diagram of an FCoE network 100 illustrating communication of FCoE frames between an edge device 102 and FCoE switches 104A and 104B via respective logical links 106A and 106B. The FCoE network 100 includes the edge device 102, FCoE switches 104A and 104B communicatively coupled to the edge device 102 via the logical links 106A and 106B, respectively. Example edge device 102 includes a host computing device or a server. In the example shown in FIG. 1, the logical link 106A (i.e., link aggregation) connects the edge device 102 and the FCoE switch 104A and the logical link 106B connects the edge device 102 and the FCoE switch 104B. Each of the logical links includes multiple FCoE links connected between multiple ports 110A of the edge device 102 and multiple ports 110B and 1100 of the FCoE switches 104A and 104B, respectively. For example, some of ports may be grouped into the logical link based on link down and/or link up states that are maintained in an aggregation control. The grouping of ports based on link down and link up states is explained in detail in FIGS. 6 and 7.

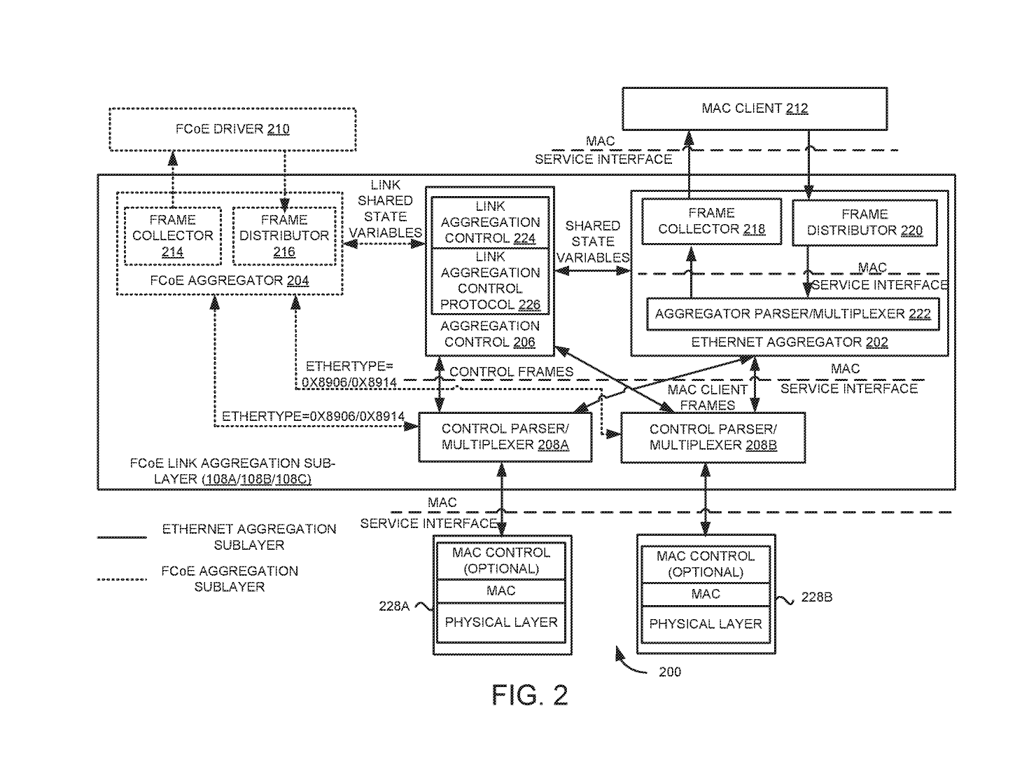

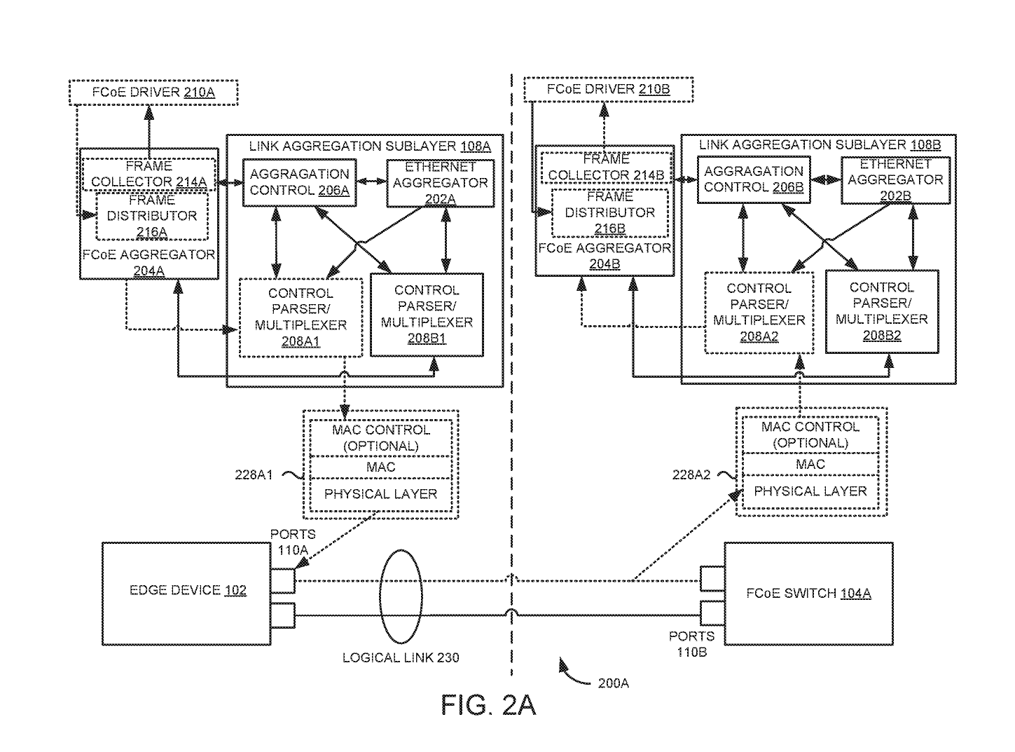

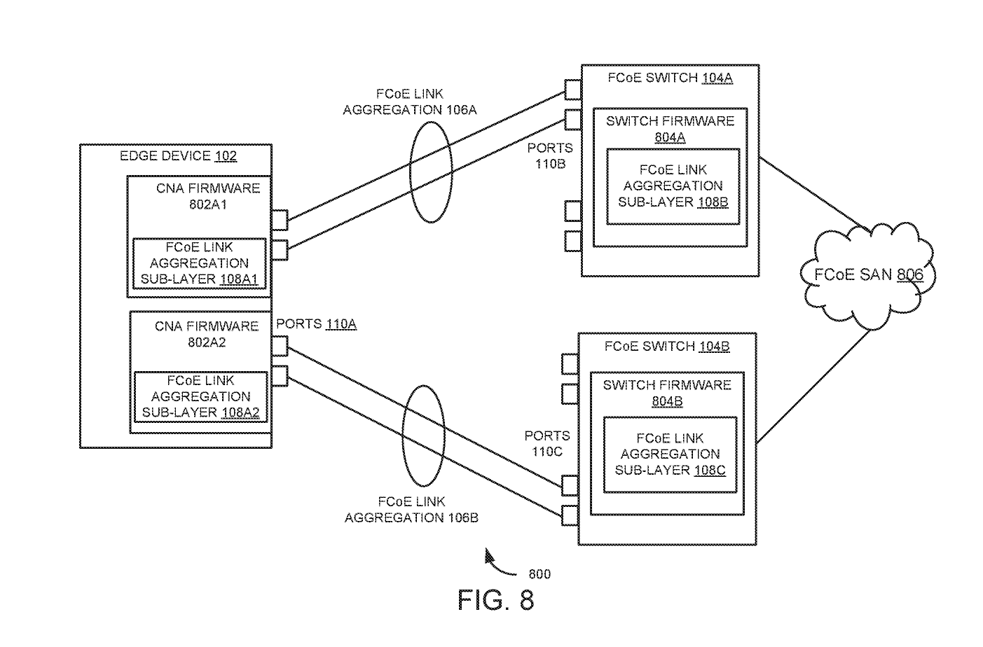

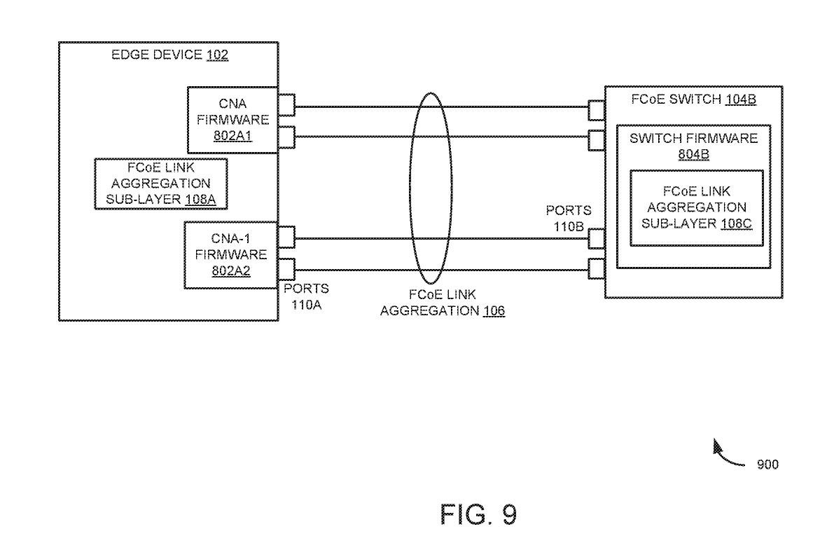

The edge device 102 includes an FCoE link aggregation sub-layer 108A. In one example, the FCoE link aggregation sub-layer 108A resides in each plurality of converged network adapters (CNA) of the host computing system. This is explained in detail in FIG. 8. In another example, the FCoE link aggregation sub-layer 108A resides in an operating system of the edge device 102. This is explained in detail in FIG. 9. Further, each of the FCoE switches 104A and 104B may include FCoE link aggregation sub-layers (e.g., FCoE link aggregation sub-layers 108B and 1080, respectively, as shown in FIG. 2). In one example, the FCoE link aggregation sub-layer in the FCoE switches 104A and 104B may reside in an associated firmware of FCoE switches 104A and 104B.

In operation, the FCoE link aggregation sub-layer 108A and the FCoE link aggregation sub-layer (e.g., FCoE link aggregation sub-layers 108B or 108C) may enable transmission and reception of FCoE frames between the edge device 102 and the FCoE switches 104A and 104B via the logical links 106A and 106B, respectively.

In one example, the FCoE link aggregation sub-layer 108A includes an FCoE aggregator and multiple control parsers/multiplexers communicatively coupled to the FCoE aggregator. In one example, each control parser/multiplexer is associated with one port of the edge device 102. On the edge device 102 side, the FCoE aggregator selects at least one of the multiple FCoE links in the logical link 106A for forwarding the FCoE frames to the FCoE switch 104A using an aggregation control. For example, the FCoE aggregator in the edge device selects the at least one of the multiple FCoE links in the logical link for forwarding the FCoE frames based on a hashing technique/load balancing policy. Further, one of the control parsers/multiplexers in the edge device forwards the FCoE frames to the FCoE switch 104A via the selected at least one of the multiple FCoE links. Furthermore, one of the control parsers/multiplexers in the edge device receives response FCoE frames (e.g., in response to the FCoE frames forwarded to the FCoE switch 104A) from the FCoE switch 104A via the logical link 106A. Also, the control parser/multiplexer in the edge device forwards the response FCoE frames to the FCoE aggregator in the edge device 102. The FCoE aggregator in the edge device forwards the response FCoE frames to an FCoE driver in the edge device 102 and then to a higher level protocol layer.

The FCoE link aggregation sub-layer in the FCoE switch 104A includes an FCoE aggregator and multiple control parsers/multiplexers communicatively coupled to the FCoE aggregator. In one example, each control parser/multiplexer is associated with one port of the FCoE switch. On the FCoE switch 104A side, one of the control parsers/multiplexers receives the FCoE frames from the FCoE link aggregation sub-layer 108A via the logical link 106A and forwards the FCoE frames to the FCoE aggregator in the FCoE switch 104A.

Further, the FCoE aggregator in the FCoE switch forwards the FCoE frames to a target device in an FCoE SAN. Example target device is a storage device or storage array. Furthermore, the FCoE aggregator in the FCoE switch receives the response FCoE frames from the target device. Also, the FCoE aggregator in the FCoE switch selects at least one of the multiple FCoE links in the logical link for forwarding the response FCoE frames using a load balancing policy. In addition, one of the control parsers/multiplexers in the FCoE switch transmits the response FCoE frames coming from the FCoE SAN network to the edge device via the selected at least one of the multiple FCoE links. The transmission and reception of FCoE frames and Ethernet frames between the edge device and the FCoE switch via the logical link is explained in detail in FIGS. 2 and 2A.

Turning now to FIG. 2, which is an example block diagram 200 of the FCoE link aggregation sub-layer illustrating FCoE aggregation integrated with Ethernet aggregation, according to one aspect of the present subject matter. For example, the modules shown in block diagram 200 can reside in an edge device (e.g., host computing system) side and in the FCoE switch side to enable communication of FCoE frames between the edge device and the FCoE switch. The block diagram 200 includes an FCoE link aggregation sub-layer (e.g., the FCoE link aggregation sub-layer 108A residing in the edge device 102 and/or the FCoE link aggregation sub-layer 108B and 1080 residing in the FCoE switches 104A and 104B, respectively). The FCoE link aggregation sub-layer 108A/108B/108C includes an Ethernet aggregator 202 communicatively coupled to a MAC client 212. Further, the FCoE link aggregation sub-layer 108A/108B/108C includes an FCoE aggregator 204 communicatively coupled to an FCoE driver 210. Also, the FCoE link aggregation sub-layer 108A/108B/108C includes an aggregation control 206 communicatively coupled to the Ethernet aggregator 202 and the FCoE aggregator 204. In one example, the Ethernet aggregator 202 and the FCoE aggregator 204 can be any combination of hardware and programming to implement the functionalities described herein.

In operation, the MAC client 212 communicates with a set of ports through an Ethernet aggregator 202 through a service interface (e.g., IEEE 802.3) to the MAC client 212. The Ethernet aggregator 202 binds to ports within a system. Further, the Ethernet aggregator 202 includes a frame distributer 220 to distribute Ethernet frames from the MAC client 212 to the ports via an aggregator parser/multiplexer 222 and control parsers/multiplexers 208A/208B. Furthermore, the Ethernet aggregator 202 includes a frame collector 218 to collect received Ethernet frames from the ports via the aggregator parser/multiplexer 222 and control parser/multiplexer 208A/208B and pass them to the MAC client 212 transparently. The binding of the ports to the Ethernet aggregator 202 within the system is managed by the aggregation control 206 in the system. The aggregation control 206 includes a link aggregation control 224 and a link aggregation control protocol (LACP) 226, which are responsible for determining links to be aggregated, aggregating the links to form a logical link, binding the ports within the system to an appropriate logical link, and monitoring conditions to determine when a change in aggregation for the logical links is needed. In one example, network interface card (NIC) bonding drivers may implement the LACP 226 to enable automatic configuration and maintenance of the aggregations between the edge device 102 and the FCoE switch 104A and/or 104B.

Further, the FCoE aggregator 204 enables aggregation of FCoE links at the edge device's side of the FCoE SAN fabric. If a target has a native FCoE port support and connects directly to an FCoE switch, then the physical links can be aggregated. The aggregation can be accomplished using the FCoE aggregator 204 layered between the FCoE driver 210 and the MAC layer 228A/228B at the edge device. In the example shown in FIG. 2, the MAC layer includes an optional MAC control, MAC, and a physical layer.

In one example, the FCoE aggregator 204 is a logical entity, and higher layer drivers can see one logical link/aggregated FCoE port. For example, the higher layer driver may receive a single FCoE World Wide Name (WWN), which may correspond to the aggregated MAC address maintained by the Ethernet aggregator 202 and a single FC address corresponding to the aggregated link. On the switch side, the FCoE Aggregator 204 may ensure a single FC address is generated by the fabric for the aggregated link. Also, the virtual local area network (VLAN) identifier configured for FCoE traffic can be a single VLAN identifier maintained across the links by the FCoE aggregator 204.

The FCoE aggregator 204 includes a frame distributor 216 and a frame collector 214. In one example, the frame distributor on both sides of the logical link takes the FCoE frames from a higher level protocol layer (e.g., FCoE driver 210) and distributes the FCoE frames on any of the links in the logical link based on a load balancing policy. Further, the frame collector 214 on both sides of the logical link receives the FCoE frames (i.e., response) across the multiple links and forwards the response FCoE frames to the higher level protocol layer. The functions of the frame distributer 216 and frame collector 214 on the edge device 102 and the FCoE switch (e.g.,104A and/or 104B) are explained in detail below.

For example, consider the FCoE aggregator includes a frame distributer and a frame collector on the edge device side. In operation, the FCoE frames that are constructed by FCoE driver/firmware are distributed by the frame distributor in the edge device across the links in the logical link based on a load balancing policy. Further, the Ethernet frame ordering can be maintained by ensuring that the FCoE frames of a particular conversation are passed through a single link. Further, any duplication of an FCoE frame may be prevented. The frame distributor in the edge device maintains the frame ordering constraints. The order of the frames in an exchange or sequence received by the frame distributor in the edge device from the higher layer can be maintained using a load balancing policy. For example, the load balancing policy can be based on fabric identifier source address or destination address from the Fibre Channel Protocol (FCP) header and the number of links available in the link aggregation. Using fabric identifier address as input for hashing technique may keep the distribution logic simple as the frame distributer in the edge device can exclude any exchange/sequence state information to be maintained by the FCoE aggregator.

Similarly, consider the FCoE aggregator includes a frame distributer and a frame collector on the FCoE switch side. The response FCoE frames that are received from the target ports and headed for the aggregated initiator port can be distributed by the frame distributor in the FCoE switch by a hashing technique based on the fabric identifier source address or destination address from the FC protocol header and the number of links available in the link aggregation. In another example, the hashing technique can be implemented at an application-specific integrated circuit (ASIC) level in the FCoE switch.

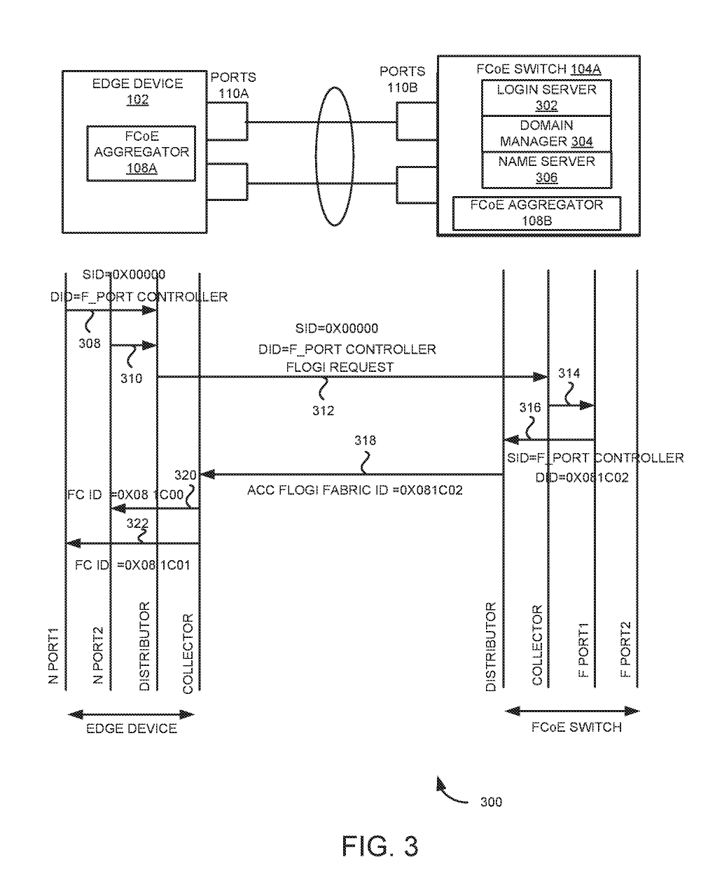

In one example, conversations may be moved by the frame distributor among the ports within the logical link, for instance, for load balancing or due to link failures. In another example, the data frames (e.g., FCP read and write) and the control frames (e.g., FCoE Initialization Protocol (FIP) frames and extended link service (ELS) frames) received by the frame distributor can be distributed across any of the links based on the selected link by the hashing technique/load balancing policy. The example distribution of FCP read, FCP write (i.e., data exchanges) and FIP FLOGI (i.e., control frame) are explained in FIGS. 3-5.

Further, the FCoE aggregator's frame collector 214 on the edge device and FCoE switch receives the incoming FCoE frames from the set of individual links that form the FCoE aggregation, and delivers the FCoE frames to the FCoE driver 210.

Furthermore, the aggregation control 206 maintains a state machine on a per-port basis, based on the information exchanged with the LACP 226 in the peer physical port and the aggregation configuration information that resides locally on the edge device or the FCoE switch. The state machine attaches a port to an Ethernet aggregator 202 and for turning on/off the distribution/collection in the Ethernet aggregation as per the information exchanged and agreed with the peer physical port.

The FCoE aggregator 204 refers the states of the links shared with the state machine maintained by the aggregation control 206 such that FCoE conversations across different links can be moved within the FCoE aggregation whenever a link failure is detected or a previously down link has come back up in an aggregated link. This is explained in detail in FIGS. 6 and 7. The FCoE aggregation corresponds to the Ethernet aggregation and can use the same links as the Ethernet aggregation provided that the aggregation VLAN for FCoE is set.

On transmission, the control parser/multiplexer 208A/208B may provide transparent pass-through of frames submitted by the Ethernet aggregator 202 and/or the FCoE aggregator 204 and LACP 226 to the port that is specified in the transmission request. On receipt, the control parser/multiplexer 208A/208B may decode Ethernet frames received from the various ports in the link aggregation group, passes the Ethernet frames destined for the LACP to an appropriate entity, and passes all other frames to the aggregator parser. For FCoE aggregation, the control parser/multiplexer 208A/208B per physical port decodes the FCoE frames based on the EtherType field (e.g., 0x8906—FCoE, 0x8914—FIP) in the Ethernet protocol header and pass the FCoE frames to the FCoE aggregator 204. In one example, control parser/multiplexer 208A/208B determines whether the frame coming from the logical link/link aggregation is an Ethernet frame or an FCoE frame and forwards the frame to one of the FCoE aggregator and the Ethernet aggregator based on the outcome of the determination. An example implementation of transmission of FCoE frames from the edge device to the FCoE switch via the logical link is shown in FIG. 2A. Even though FIG. 2 is explained with respect to two control parsers/multiplexers 208A and 208B, any number of control parsers/multiplexers can be configured in the edge device or FCoE switch with each control parser/multiplexer being associated with a port.

FIG. 2A is a block diagram 200A showing example implementation of transmission of FCoE frames between the edge device 102 and the FCoE switch 104A via the logical link 230. In the example shown in FIG. 2A, the edge device 102 includes FCoE aggregator 204A and FCoE switch 104A includes FCoE aggregator 204B. In operation, the frame distributer 216A in the edge device 102 selects one of the multiple FCoE links in the logical link 230 for forwarding the FCoE frames using the aggregation control 206A. Further, the control parser/multiplexer 208A1 receives and forwards the FCoE frames to the FCoE switch 104A via the selected one of the multiple FCoE links and the MAC layer 228A1.

Furthermore, the control parser/multiplexer 208A2 in the FCoE switch 104A receives the FCoE frames from the edge device 102 via the logical link 230 and the MAC layer 228A2 and forwards the FCoE frames to the FCoE aggregator 204B in the FCoE switch 104A. The frame collector 214B in the FCoE switch 104A collects and forwards the FCoE frames to a target device in an FCoE SAN. Similarly, the FCoE switch 104A transmits the response to the FCoE frames coming from the target device to the edge device 102 via the logical link 230.

FIG. 3 is a timing diagram 300 illustrating an example fabric login (FLOGI) scenario between the edge device 102 and the FCoE switch 104A, according to one aspect of the present subject matter. The FCoE switch 104A includes a login server 302, a domain manager 304, and a name server 306. The login server 302 may be an application that facilitates authentication of an entity that attempts to access a network. The domain manager 304 may perform domain name services. Further, the name server 306 may implement a network service for providing responses to queries against a directory service.

In operation, an FLOGI request is received at the edge device 102. The distributer function at the edge device 102 receives the FLOG I request (e.g., at 308 and 310) and forwards the FLOGI request to the FCoE switch 104A via a logical link (e.g., at 312). Further, the frame collector at the FCoE switch 104A receives the FLOGI request and forwards an accept (ACC) of the FLOGI by the FCoE switch 104A to the edge device 102 in response to the FLOGI request via the logical link (e.g., at 314, 316 and 318) and forwards the ACC to higher protocol layers (e.g., at 320 and 322).

In Reference to FIG. 3, there is one FLOGI for the aggregated node ports and one fabric identifier is returned by a fabric controller to the aggregated port. The collector function of the aggregator assigns separate fabric identifiers to N Ports on the edge device side.

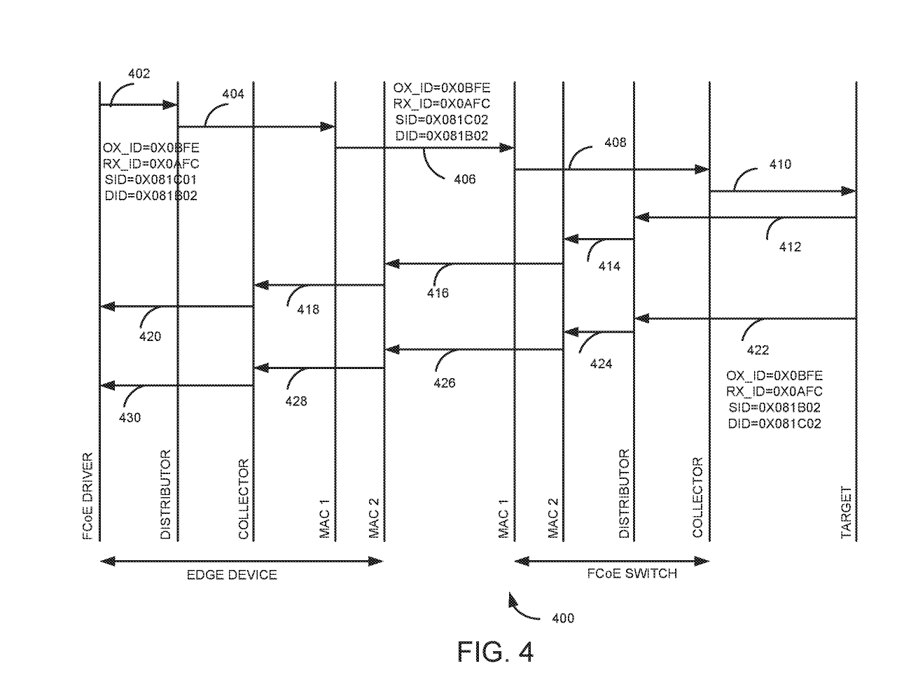

FIG. 4 is a timing diagram 400 illustrating an example FCoE read exchange scenario, according to one aspect of the present subject matter. As shown in FIG. 4, the FCoE driver in a host computing device sends a READ command to a target device (e.g., at 402). The distributor on the host computing device's FCoE aggregator decides to send the command through link-1 (e.g., at 404 and 406) with the source identifier (SID) as the aggregated SID. The collector on the FCoE switch receives the command (e.g., at 408). The FCoE switch then forwards the request to the target device (e.g., at 410). The target device sends the DATA frames (i.e., FCoE frames) to the aggregated destination identifier (DID) (e.g., at 412). The distributor on the FCoE switch decides to send the DATA frames through link-2 (e.g., at 414 and 416). The collector on the host computing system receives the DATA frames (e.g., at 418) and then forwards the data frames to the FCoE driver (e.g., at 420). The target device then sends the STATUS command to the host computing system with the aggregated DID (e.g., at 422). The distributor on the FCoE switch decides to send the STATUS frame through Link-2 (e.g., at 424 and 426). The collector on the host computing system receives the STATUS frame (e.g., at 428) and then forwards the STATUS frame to the FCoE driver (e.g., at 430).

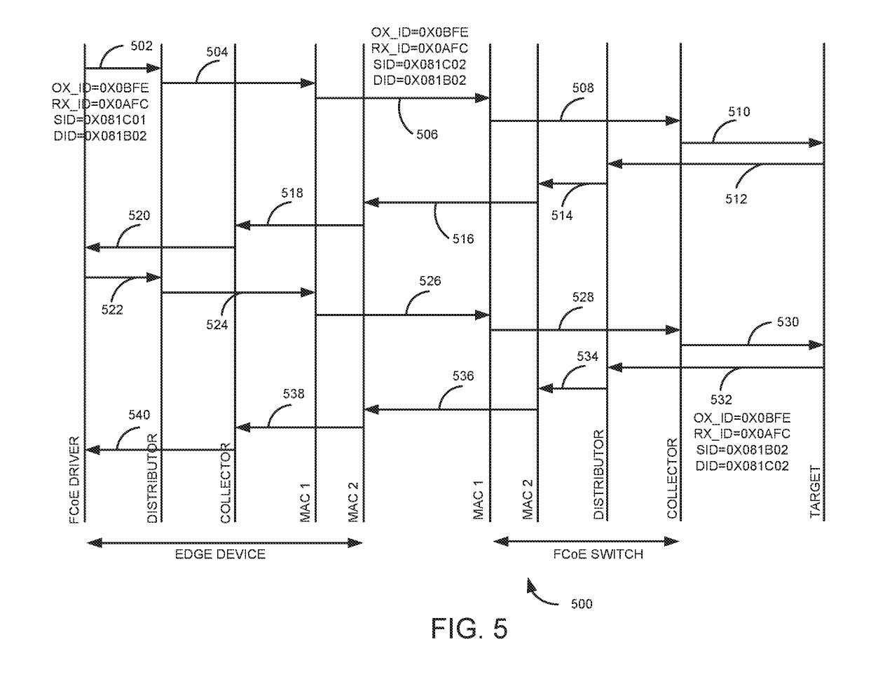

FIG. 5 is a timing diagram 500 illustrating an example WRITE exchange scenario, according to one aspect of the present subject matter. As shown in FIG. 5, the FCoE driver in a host computing system sends a WRITE command to a target device (e.g., at 502). The distributor on the host computing system's FCoE aggregator decides to send the WRITE command through a link in the logical link (e.g., Link-1) (e.g., at 504 and 506) with the SID as the aggregated SID. The collector on the FCoE switch receives the WRITE command (e.g., at 508). The FCoE switch then forwards the WRITE command to the target device (e.g., at 510). The target device sends a TRANSFER READY (XFR_RDY) frame to the host computing device with the aggregated DID (e.g., at 512). The distributor on the FCoE switch decides to send the XFR_RDY frame through link-2 (e.g., at 514 and 516). The collector on the host computing system receives the XFR_RDY frame (e.g., at 518) and then forwards the XFR_RDY frame to the FCoE driver (e.g., at 520). The FCoE driver sends the DATA frame to the target device (e.g., at 522). The distributor on the host computing system chooses link-1 to send the DATA frames with the SID as the aggregated SID (e.g., 524 and 526). The collector on the FCoE switch receives the DATA frames (e.g., at 528) and forwards the frames to the target device (e.g., at 530). When the FCoE driver completes sending all the DATA frames, the target device sends the STATUS command to the host computing system with the aggregated DID (e.g., at 532). The distributor on the FCoE switch decides to send the STATUS frame through link-2 (e.g., at 534 and 536). The collector on the host computing system receives the STATUS frame (e.g., at 538) and then forwards the STATUS frame to the FCoE driver (e.g., at 540).

FIG. 6 is a block diagram 600 illustrating an example handling of link down scenario in the integrated FCoE and Ethernet aggregation, such as those shown in FIGS. 1 and 2, according to one aspect of the present subject matter. In the example shown in FIG. 6, one of the links in the logical link/aggregated channel goes down (e.g., as shown by 602). The FCoE aggregator 204 communicates with the aggregation control 206 through the link shared state variables and is aware of the link which is down (e.g., as shown by 604). The distributor 216 in the FCoE aggregator 204 sends the FCoE frames to the control parser/multiplexer 208A of the Peripheral Component Interconnect (PCI) port, whose link is online (e.g., as shown by 606). The control parser 208A sends the frames down to the MAC layer 228A of that port/link (e.g., as shown by 608).

FIG. 7 is a block diagram 700 illustrating an example handing of link add scenario in the integrated FCoE and Ethernet aggregation, such as those shown in FIGS. 1 and 2, according to one aspect of the present subject matter. In the example shown in FIG. 7, one of the links in the logical link/aggregated channel comes up (i.e., back to working) (e.g., as shown by 702). The FCoE aggregator 204 communicates with the aggregation control 206 through the link shared state variables and is aware of the link which is back online/working (e.g., as shown by 704). The frame distributor 216 in the FCoE aggregator 204 multiplexes the FCoE frames to the control parsers/multiplexers 208A and 208B of both the PCI ports (e.g., as shown by 706 and 710). The control parsers 208A and 208B send the FCoE frames down to the MAC layers 228A and 228B of that port/link (e.g., as shown by 708 and 712). Further, the deployment can be done in two parts, i.e., in the FCoE switch and in the CNA of the edge device.

FIG. 8 is a block diagram 800 illustrating an example implementation of the FCoE aggregator in a Converged Network Adapter (CNA) firmware, according to one aspect of the present subject matter. In the example shown in FIG. 8, the edge device 102 includes CNA firmware 802A1 and 802A2. Further, the CNA firmware 802A1 and 802A2 include FCoE link aggregation sub-layers 108A1 and 108A2, respectively. Furthermore, the FCoE switches 104A and 104B include switch firmware 804A and 804B, respectively. The switch firmware 804A and 804B include FCoE link aggregation sub-layers 108B and 108C, respectively. Further, the FCoE switches 104A and 104B are connected to an FCoE SAN 806 to forward the FCoE frames coming from the edge device 102 to a target device in the FCoE SAN 806 and receive response to the FCoE frames from the target device. In the example shown in FIG. 8, on the edge device side 102, the FCoE aggregation can be implemented in the CNA firmware (i.e., 802A1 and/or 802A2). On the FCoE switches 104A and 104B, the FCoE aggregator can be implemented in the FCoE switch firmware 804A and 804B.

FIG. 9 is a block diagram 900 illustrating an example implementation of FCoE aggregation in a host computing device/operating system, according to one aspect of the present subject matter. In the example shown in FIG. 9, the edge device 102 includes CNA firmware 802A1 and 802A2. Further, the edge device 102 includes FCoE link aggregation sub-layer 108A. In the example shown in FIG. 9, on the edge device side 102, the FCoE aggregation is implemented in OS of the edge device (e.g., as a driver). On the FCoE switches 104B, the FCoE aggregator can be implemented in the FCoE switch firmware 804B.

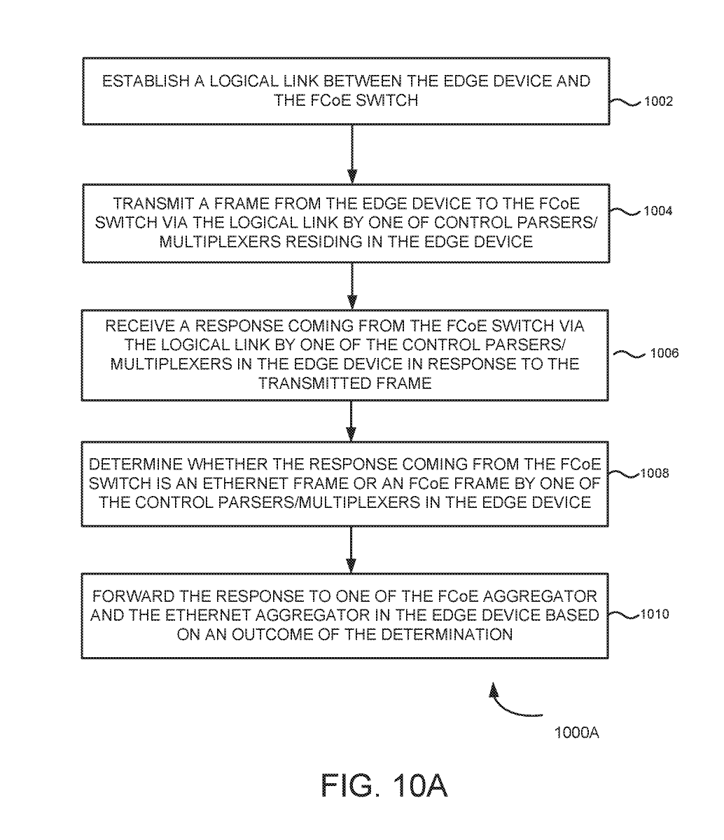

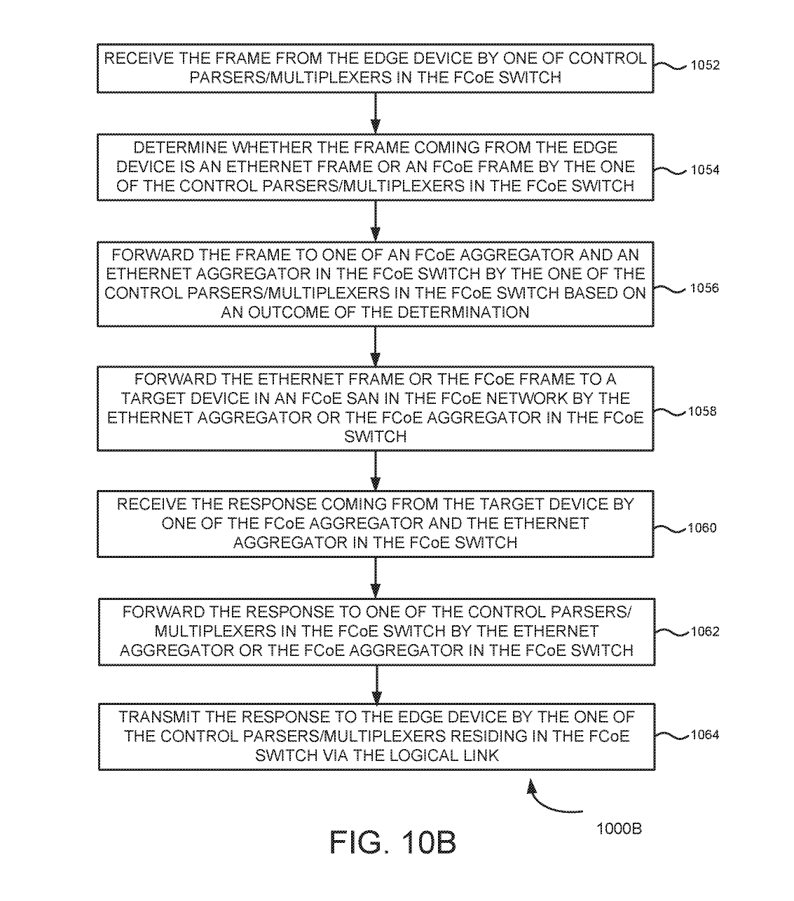

Turning now to FIGS. 10A and 10B, which depict example flow charts for FCoE aggregation between an edge device and an FCoE switch in an FCoE network. Particularly, FIG. 10A illustrates the FCoE aggregation 1000A on the edge device. At 1002, a logical link is established between the edge device and the FCoE switch. The logical link includes multiple physical links connected between multiple ports of the edge device and the FCoE switch. At 1004, a frame is transmitted from the edge device to the FCoE switch via the logical link by one of multiple control parsers/multiplexers residing in the edge device. In one example, the frame includes an Ethernet frame coming from an Ethernet aggregator residing in the edge device or an FCoE frame coming from an FCoE aggregator residing in the edge device. For example, Ethernet frame includes one of a data frame and a control frame. Example control frame includes an FCoE Initialization Protocol (FIP) frames. Example FCoE frame includes a read command and/or a write command.

At 1006, a response coming from the FCoE switch, in response to the transmitted frame, is received via the logical link by one of the control parsers/multiplexers in the edge device. At 1008, a determination is made to check whether the response coming from the FCoE switch is an Ethernet frame or an FCoE frame by the one of the control parsers/multiplexers (e.g., that receives the response) in the edge device. In one example, determining whether the response coming from the FCoE switch is an Ethernet frame or an FCoE frame by the control parser/multiplexer in the edge device includes parsing a header associated with the response to determine an EtherType of the incoming response and declaring the incoming response as an FCoE frame or Ethernet frame based on the outcome of the determination of the EtherType of the response. For example, the EtherType is a two-octet field for an Ethernet frame and the EtherType is 8906 or 8914 for an FCoE frame. For example, if the EtherType is 8906 (e.g., FCoE) or 8914 (e.g., FIP), then the response is declared as FCoE frame, else the response is declared as Ethernet frame.

At 1010, the response is forwarded to the FCoE aggregator or the Ethernet aggregator in the edge device based on the outcome of the determination. In one example, if the response coming from the FCoE switch is an Ethernet frame, then the response is forwarded to the Ethernet aggregator in the edge device and if the response coming from the FCoE switch is an FCoE frame, then the response is forwarded to the FCoE aggregator in the edge device.

Further, FIG. 10B illustrates the FCoE aggregation 1000B on the FCoE switch. At 1052, the frame transmitted from the edge device is received by one of multiple control parsers/multiplexers in the FCoE switch. At 1054, it is determined whether the frame coming from the edge device is an Ethernet frame or an FCoE frame by the one of the control parsers/multiplexers (e.g., that receives the frame) in the FCoE switch. In one example, whether the frame coming from the edge device is the Ethernet frame or the FCoE frame is determined by parsing a header associated with the frame to determine an EtherType of the frame, and declaring the frame as an FCoE frame or Ethernet frame based on the outcome of the determination of the EtherType of the frame. For example, if the EtherType is 8906 (e.g., FCoE) or 8914 (e.g., FIP), then the frame is declared as FCoE frame, else the frame is declared as Ethernet frame.

At 1056, the frame is forwarded to an FCoE aggregator or an Ethernet aggregator in the FCoE switch by the control parser/multiplexer in the FCoE switch based on the outcome of the determination. In one example, if the frame coming from the edge device is an Ethernet frame, then the frame is forwarded to the Ethernet aggregator in the FCoE switch and if the frame coming from the edge device is an FCoE frame, then the frame is forwarded to the FCoE aggregator in the FCoE switch.

At 1058, the Ethernet frame or the FCoE frame is forwarded to a target device in the FCoE SAN in the FCoE network by the Ethernet aggregator or the FCoE aggregator in the FCoE switch. At 1060, the response coming from the target device is received by one of the FCoE aggregator and the Ethernet aggregator in the FCoE switch. For example, the response coming from the target device in the FCoE SAN network is received by the FCoE aggregator in the FCoE switch and the response coming from the target device in the LAN network is received by the Ethernet aggregator in the FCoE switch.

In case of Fabric Login (FLOGI), the accept (ACC) (i.e., response) of FLOG I is transmitted by the FCoE switch through the logical link. This is explained in detail in FIG. 3. In case of READ command, the data frames (i.e., response) are transmitted by the target device followed by sending a status (i.e., response) to the edge device via FCoE switch and the logical link. This is explained in detail in FIG. 4. In case of WRITE command, a TRANSFER READY frame (i.e., response) is transmitted by the target device to the edge device via FCoE switch and the logical link. Then the data frames are transmitted by the edge device to the target device via the logical link and the FCoE switch, and then a status (i.e., response) is transmitted by the target device to the edge device via the FCoE switch and the logical link. This is explained in detail in FIG. 5.

At 1062, the response is forwarded to one of the control parsers/multiplexers in the FCoE switch by the Ethernet aggregator or the FCoE aggregator in the FCoE switch. At 1064, the response is transmitted to the edge device by the control parser/multiplexer residing in the FCoE switch via the logical link.

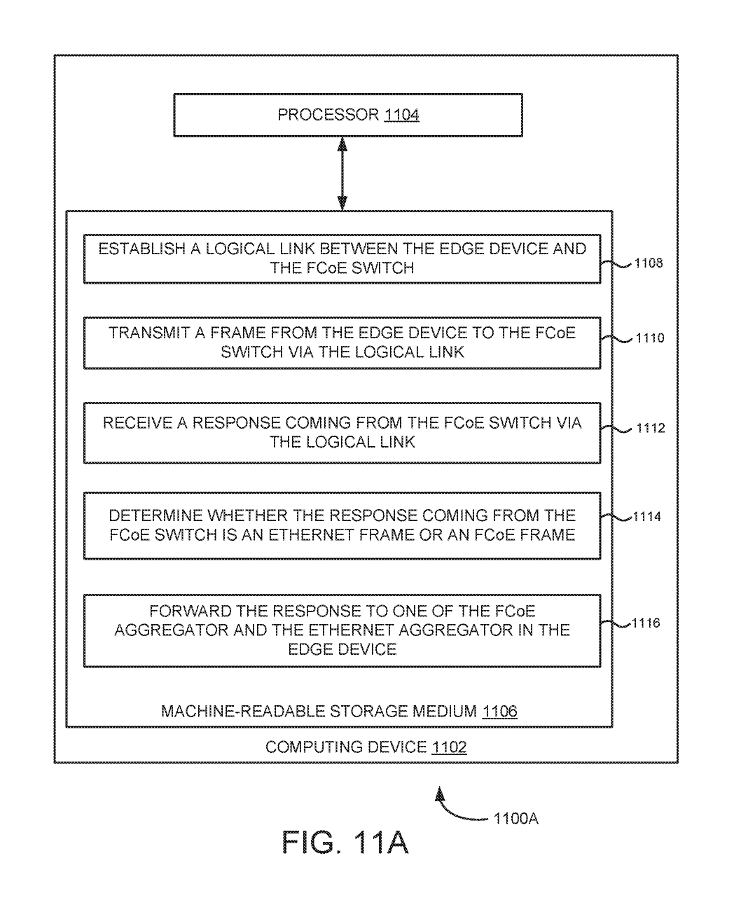

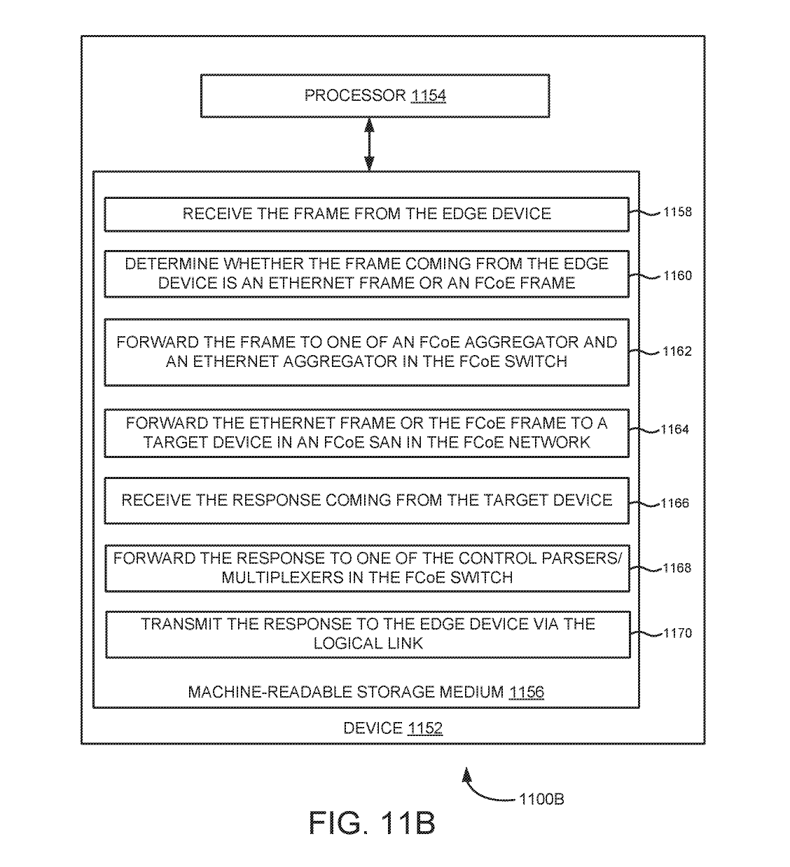

FIGS. 11A and 11B is example block diagrams 1100A and 1100B showing a non-transitory computer-readable media that stores code for operation in accordance with an example of the techniques of the present application. Particularly FIG. 11A illustrates host side implementation of LAG function and FIG. 11 B illustrates switch side implementation of LAG function. The non-transitory computer-readable media includes a machine readable storage medium 1106 on the edge device side and machine readable storage medium 1156 on the FCoE switch side. The non-transitory computer-readable media is generally referred to by the reference number 1106 and 1156 and may be included in a computing system 1102 (e.g., an edge device) and device 1152 (e.g., an FCoE switch), respectively. The non-transitory computer-readable medium 1106 and 1156 may correspond to any storage device that stores computer-implemented instructions, such as programming code or the like. For example, the non-transitory computer-readable medium 1106 and 1156 may include non-volatile memory, volatile memory, and/or storage devices. Examples of non-volatile memory include, but are not limited to, electrically erasable programmable Read Only Memory (EEPROM) and Read Only Memory (ROM). Examples of volatile memory include, but are not limited to, Static Random Access Memory (SRAM), and dynamic Random Access Memory (DRAM). Examples of storage devices include, but are not limited to, hard disk drives, compact disc drives, digital versatile disc drives, optical drives, and flash memory devices.

Processors 1104 and 1154 generally retrieve and execute the instructions stored in the non-transitory computer-readable medium 1106 and 1156 respectively, to operate the present techniques in accordance with an example. In one example, the tangible, computer-readable media 1106 and 1156 can be accessed by the respective one of the processors 1104 and 1154 over a bus.

The machine-readable storage media 1106 may store instructions 1108-1116. In an example, instructions 1108-1116 may be executed by the processor 1104 on the computing device/host 1102 to provide a mechanism for host side implementation of LAG function. Instructions 1108 may be executed by the processor 1104 to establish a logical link between the edge device and the FCoE switch. Instructions 1110 may be executed by the processor 1104 to transmit a frame from the edge device to the FCoE switch via the logical link by one of multiple control parsers/multiplexers residing in the edge device. Instructions 1112 may be executed by the processor 1104 to receive a response coming from the FCoE switch via the logical link by one of the control parsers/multiplexers in response to the forwarded Ethernet frame or the FCoE frame. Instructions 1114 may be executed by the processor 1104 to determine whether the response coming from the FCoE switch is an Ethernet frame or an FCoE frame by the control parser/multiplexer that receives the response. Instructions 1116 may be executed by the processor 1104 to forward the response to one of the FCoE aggregator and the Ethernet aggregator in the edge device based on the outcome of the determination.

The machine-readable storage media 1156 may store instructions 1158-1170. In an example, instructions 1158-1170 may be executed by the processor 1154 on the device/FCoE switch 1152 to provide a mechanism for switch side implementation of LAG function. Instructions 1158 may be executed by the processor 1154 to receive the frame from the edge device by one of control parsers/multiplexers in the FCoE switch. Instructions 1160 may be executed by the processor 1154 to determine whether the frame coming from the edge device is the Ethernet frame or the FCoE frame by the control parser/multiplexer (e.g., that receives the frame) in the FCoE switch. Instructions 1162 may be executed by the processor 1154 to forward the frame to one of an FCoE aggregator and an Ethernet aggregator in the FCoE switch based on the outcome of the determination. Instructions 1164 may be executed by the processor 1154 to forward the Ethernet frame or the FCoE frame to a target device in the FCoE SAN in the FCoE network by the Ethernet aggregator or the FCoE aggregator in the FCoE switch, respectively. Instructions 1166 may be executed by the processor 1154 to receive the response coming from the target device by one of the FCoE aggregator and the Ethernet aggregator in the FCoE switch. Instructions 1168 may be executed by the processor 1154 to forward the response to one of the control parsers/multiplexers in the FCoE switch by the Ethernet aggregator or the FCoE aggregator in the FCoE switch. Instructions 1170 may be executed by the processor 1154 to transmit the response to the edge device by the control parser/multiplexer residing in the FCoE switch via the logical link.

Although shown as contiguous blocks, the machine readable instructions can be stored in any order or configuration. For example, if the non-transitory computer-readable media 1106 and 1156 is a hard drive, the machine readable instructions can be stored in non-contiguous, or even overlapping, sectors.

As used herein, a “processor” may include processor resources such as at least one of a Central Processing Unit (CPU), a semiconductor-based microprocessor, a Graphics Processing Unit (GPU), a Field-Programmable Gate Array (FPGA) to retrieve and execute instructions, other electronic circuitry suitable for the retrieval and execution instructions stored on a computer-readable medium, or a combination thereof. The processor fetches, decodes, and executes instructions stored on computer-readable medium 1102 to perform the functionalities described below. In other examples, the functionalities of any of the instructions of computer-readable media 1106 and 1156 may be implemented in the form of electronic circuitry, in the form of executable instructions encoded on a computer-readable storage medium, or a combination thereof.

As used herein, a “computer-readable medium” may be any electronic, magnetic, optical, or other physical storage apparatus to contain or store information such as executable instructions, data, and the like. For example, any computer-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any computer-readable medium described herein may be non-transitory. In examples described herein, a computer-readable medium or media is part of an article (or article of manufacture). An article or article of manufacture may refer to any manufactured single component or multiple components. The medium may be located either in the system executing the computer-readable instructions, or remote from but accessible to the system (e.g., via a computer network) for execution. In the example of FIG. 11, computer-readable media 1106 and 1156 may be implemented by one computer-readable medium, or multiple computer-readable media.

In examples described herein, the source system may communicate with the destination system via a network interface device. In examples described herein, a “network interface device” may be a hardware device to communicate over at least one computer network. In some examples, a network interface may be a Network Interface Card (NIC) or the like. As used herein, a computer network may include, for example, a Local Area Network (LAN), a Wireless Local Area Network (WLAN), a Virtual Private Network (VPN), the Internet, or the like, or a combination thereof. In some examples, a computer network may include a telephone network (e.g., a cellular telephone network).

In some examples, instructions may be part of an installation package that, when installed, may be executed by processors 1104 and 1154 to implement the functionalities described herein in relation to instructions. In such examples, computer-readable media 1106 and 1156 may be a portable medium, such as a CD, DVD, or flash drive, or a memory maintained by a server from which the installation package can be downloaded and installed. In other examples, instructions may be part of an application, applications, or component(s) already installed on the computing system 1102 and device 1152 including processors 1104 and 1154, respectively. In such examples, the computer-readable media 1106 and 1156 may include memory such as a hard drive, solid state drive, or the like.

It may be noted that the above-described examples of the present solution is for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on,” as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A Fibre Channel over Ethernet (FCoE) network, comprising:
an edge device, wherein the edge device comprises:
an edge device FCoE link aggregation sub-layer; and
a logical link to connect the edge device to an FCoE switch, the logical link comprising multiple FCoE links connected to multiple ports of the edge device, wherein the edge device FCoE link aggregation sub-layer to enable transmission and reception of FCoE frames from/to the edge device via the logical link.

2. The FCoE network of claim 1, wherein the edge device FCoE link aggregation sub-layer comprises:
an FCoE aggregator to select at least one of the multiple FCoE links in the logical link to forward the FCoE frames using an aggregation control; and
multiple control parsers/multiplexers communicatively coupled to the FCoE aggregator, wherein control parsers/multiplexers in the edge device to:
forward the FCoE frames to the FCoE switch via the selected at least one of the multiple FCoE links;
receive response FCoE frames from the FCoE switch via the logical link in response to the forwarded FCoE frames; and
forward the response FCoE frames to the FCoE aggregator in the edge device, wherein the FCoE aggregator in the edge device to forward the response FCoE frames to an FCoE driver in the edge device.

3. The FCoE network of claim 2, wherein the FCoE aggregator in the edge device to select the at least one of the multiple FCoE links in the logical link to forward the FCoE frames based on a load balancing policy.

4. The FCoE network of claim 2, wherein the FCoE switch comprises:
a switch FCoE link aggregation sub-layer, wherein the multiple FCoE links in the logical link are connected between the multiple ports of the edge device and multiple ports of the FCoE switch.

5. The FCoE network of claim 4, wherein the switch FCoE link aggregation sub-layer comprises:
an FCoE aggregator; and
multiple control parsers/multiplexers communicatively coupled to the FCoE aggregator in the FCoE switch, wherein the control parsers/multiplexers in the FCoE switch to receive the FCoE frames from the edge device FCoE link aggregation sub-layer via the logical link and forward the FCoE frames to the FCoE aggregator in the FCoE switch, wherein the FCoE aggregator in the FCoE switch to forward the FCoE frames to a target device in an FCoE storage area network (SAN), receive the response FCoE frames from the target device, select at least one of the multiple FCoE links in the logical link to forward the response FCoE frames using a load balancing policy, and wherein the control parsers/multiplexers in the FCoE switch to transmit the response FCoE frames coming from the FCoE SAN to the edge device via the selected at least one of the multiple FCoE links.

6. The FCoE network of claim 1, wherein the edge device further comprises:
a plurality of converged network adapters (CNAs), wherein each CNA includes a plurality of ports, wherein some of the plurality of ports being grouped into the logical link based on link down and/or link add states that are maintained by a aggregation control, wherein the logical link is coupled between the plurality of CNAs and the FCoE switch, and wherein the edge device FCoE link aggregation sub-layer resides in each CNA or in an operating system of the edge device.

7. A method of Fibre Channel over Ethernet (FCoE) aggregation between an edge device and an FCoE switch in a Fibre Channel over Ethernet (FCoE) network, comprising:
establishing a logical link between the edge device and the FCoE switch, the logical link comprising multiple physical links connected between multiple ports of the edge device and the FCoE switch;
transmitting a frame from the edge device to the FCoE switch via the logical link by one of control parsers/multiplexers residing in the edge device, wherein the frame comprises one of an Ethernet frame and an FCoE frame coming from an Ethernet aggregator and an FCoE aggregator, respectively, in the edge device;
receiving a response coming from the FCoE switch via the logical link by one of the control parsers/multiplexers in the edge device in response to the transmitted frame;
determining whether the response coming from the FCoE switch is an Ethernet frame or an FCoE frame by one of the control parsers/multiplexers in the edge device that receives the response; and
forwarding the response to one of the FCoE aggregator and the Ethernet aggregator in the edge device based on an outcome of the determination.

8. The method of claim 7, further comprising:
receiving the frame from the edge device by one of control parsers/multiplexers in the FCoE switch;
determining whether the frame coming from the edge device is an Ethernet frame or an FCoE frame by the one of the control parsers/multiplexers in the FCoE switch that receives the frame;
forwarding the frame to one of an FCoE aggregator and an Ethernet aggregator in the FCoE switch by the one of the control parsers/multiplexers in the FCoE switch based on an outcome of the determination; and
forwarding the Ethernet frame or the FCoE frame to a target device in a FCoE SAN in the FCoE network by the Ethernet aggregator or the FCoE aggregator in the FCoE switch, respectively.

9. The method of claim 8, further comprising:
receiving the response coming from the target device by one of the FCoE aggregator and the Ethernet aggregator in the FCoE switch;
forwarding the response to one of the control parsers/multiplexers in the FCoE switch by the Ethernet aggregator or the FCoE aggregator in the FCoE switch; and
transmitting the response to the edge device by the one of the control parsers/multiplexers residing in the FCoE switch via the logical link.

10. The method of claim 9, further comprising:
when the received frame is a Fabric Login (FLOG I), then transmitting an accept (ACC) of the FLOG I by the FCoE switch to the edge device via the logical link;
when the received frame is a READ command, then transmitting data frames by the target device followed by sending a status to the edge device via the FCoE switch and the logical link; and
when the received frame is a WRITE command, then transmitting a TRANSFER READY frame by the target device to the edge device via the FCoE switch and the logical link, transmitting data frames by the edge device to the target device via the logical link and the FCoE switch, and transmitting a status by the target device to the edge device via the FCoE switch and the logical link.

11. The method of claim 8, wherein determining whether the frame coming from the edge device is the Ethernet frame or the FCoE frame by the one of the control parsers/multiplexers in the FCoE switch, comprises:
parsing a header associated with the frame to determine an EtherType of the frame; and
declaring the frame as the FCoE frame or the Ethernet frame based on an outcome of the determination of the EtherType of the frame.

12. The method of claim 7, wherein determining whether the response coming from the FCoE switch is the Ethernet frame or the FCoE frame by the one of the control parsers/multiplexers in the edge device, comprises:
parsing a header associated with the response to determine an EtherType of the incoming response; and
declaring the incoming response as the FCoE frame or the Ethernet frame based on an outcome of the determination of the EtherType of the response.

13. The method of claim 7, wherein the edge device is a host computing device, and wherein the target device is a storage device.

14. A non-transitory computer-readable media having computer executable instructions stored thereon for FCoE aggregation between an edge device and an FCoE switch, the instructions are executable by at least one processor to:
establish a logical link between the edge device and the FCoE switch, the logical link comprising multiple FCoE links connected between multiple ports of the edge device and the FCoE switch;
transmit a frame from the edge device to the FCoE switch via the logical link by one of control parsers/multiplexers residing in the edge device, wherein the frame comprises one of an Ethernet frame and an FCoE frame coming from an Ethernet aggregator and an FCoE aggregator, respectively, in the edge device;
receive a response coming from the FCoE switch via the logical link by one of control parsers/multiplexers in the edge device in response to the forwarded Ethernet frame or the FCoE frame;
determine whether the response coming from the FCoE switch is an Ethernet frame or an FCoE frame by the one of the control parsers/multiplexers in the edge device that receives the response; and
forward the response to one of the FCoE aggregator and the Ethernet aggregator in the edge device based on an outcome of the determination.

15. The non-transitory computer-readable media of claim 14, further comprising instructions to:
receive the frame from the edge device by one of control parsers/multiplexers in the FCoE switch;
determine whether the frame coming from the edge device is the Ethernet frame or the FCoE frame by the one of the control parsers/multiplexers in the FCoE switch;
forward the frame to one of an FCoE aggregator and an Ethernet aggregator in the FCoE switch based on an outcome of the determination;
forward the Ethernet frame or the FCoE frame to a target device in an FCoE SAN in the FCoE network by the Ethernet aggregator or the FCoE aggregator in the FCoE switch, respectively;
receive the response coming from the target device by one of the FCoE aggregator and the Ethernet aggregator in the FCoE switch;
forward the response to one of control parsers/multiplexers in the FCoE switch by the Ethernet aggregator or the FCoE aggregator in the FCoE switch; and
transmit the response to the edge device by the one of the control parsers/multiplexers residing in the FCoE switch via the logical link.
